(19) United States
(12) Patent Application Publication
(10) Pub. No.: US 2026/0043966 A1
(43) Pub. Date: Feb. 12, 2026

(54) OPTICAL MONITOR DEVICE, AND OPTICAL POWER AND WAVELENGTH MEASUREMENT METHOD

(71) Applicant: NIPPON TELEGRAPH AND TELEPHONE CORPORATION, Tokyo (JP)

(72) Inventors: Ryo KOYAMA, Musashino-shi, Tokyo (JP); Yoshiteru ABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/997,461

(22) PCT Filed: Jul. 28, 2022
(86) PCT No.: PCT/JP2022/029136

§ 371 Date: Jan. 21, 2025

(51) Int. Cl. G02B 6/293; G01M 11/00

(52) U.S. Cl. CPC G02B 6/29373; G01M 11/37

(57) ABSTRACT

An object of the present disclosure is to make it possible to monitor wavelengths of optical signals in an optical monitor device for a plurality of optical fibers.

The present disclosure is an optical monitor device that detects an intensity of light propagating through a plurality of optical fibers, the optical monitor device including: an optical splitting unit that splits a part of incident light from the plurality of optical fibers into a first direction and a rest into a second direction at a constant splitting ratio, and emits light; and a light receiving portion that receives emitted light in the second direction from the optical splitting unit, in which the light receiving portion includes light receiving elements larger in number than the optical fibers are two-dimensionally arranged, and a wavelength dependent portion that causes the light receiving portion to receive light at a position on a light receiving surface that varies depending on a wavelength of the emitted light, and obtains a wavelength of the emitted light on a basis of a position of the emitted light on the light receiving surface.

### TECHNICAL FIELD

The present disclosure relates to an optical monitor device, and particularly relates to an optical monitor device for detecting an intensity of light and feeding back a detection result to other components in an optical transmission device or the like.

### BACKGROUND ART

With an increase in Internet traffic, it is strongly required to increase a communication capacity in a communication system in recent years. In order to implement this, a communication system using optical fibers is used in an access network between a communication station building and a user's home or a core network connecting communication station buildings. In optical fiber communication, detection of a light intensity propagating through an optical fiber is often used for controlling communication and checking soundness of equipment. For example, in an access network, test light is propagated through optical fibers, and a loss and soundness of the optical fibers, a core target, connection, and the like are checked from detection of the light intensity. Furthermore, in wavelength division multiplexing (WDM) transmission used in a core network, it is necessary to monitor a light intensity for feedback control.

In light intensity monitoring of an access network, for example, a technology described in Patent Literature 1 is used. Patent Literature 1 describes a technology of splitting light at a constant splitting ratio by two parallel waveguides, and the technology enables measurement of an intensity and a propagation loss of an optical signal in an access network.

For light intensity monitoring in WMD transmission, for example, the technology of Patent Literature 2 is used. Patent Literature 2 describes a technology for simultaneously monitoring the intensities of optical signals of a plurality of optical fibers by a combination of one-dimensionally arranged optical fibers and a dielectric multilayer film.

However, an optical monitor device having the conventional arrangement configuration still has the following issues.

While optical communication has become widespread and the number of optical fibers of an optical facility/cable has increased, first, the cost and size increase with the increase in the optical fibers in the case of an optical monitor device using an optical coupler for each optical fiber. Also in the case of an optical monitor device in which optical fibers and light intensity sensors are arranged in a one-dimensional array, there is a limit to the array arrangement of the optical fibers, and if the number of optical fibers is increased beyond the limit, the cost and size increase according to the number.

As a spatial optical system for forming such an optical monitor device, for example, in Patent Literature 2, a dielectric multilayer film is used for optical splitting. However, since a dielectric multilayer film generally has a high light reflectance, there is an issue that a loss of a signal transmitted through the optical monitor device increases. Furthermore, since a dielectric multilayer film generally reflects only a specific wavelength band, there is an issue that a dielectric multilayer film is not suitable for monitoring communication using a wide wavelength band such as WDM transmission.

### CITATION LIST

### Patent Literature

Patent Literature 1: JP 3450104 B2
Patent Literature 2: JP 2004-219523 A

### SUMMARY OF INVENTION

### Technical Problem

As a technology for solving the above issues and enabling monitoring of optical signals in a wide wavelength range, for example, it is conceivable to extract light in a wide wavelength range using Fresnel reflection and collectively measure the intensities of optical signals of a plurality of optical fibers. However, in this method, since all wavelengths are similarly extracted, the wavelength of the extracted optical signal cannot be known.

An object of the present disclosure is to make it possible to monitor wavelengths of optical signals in a wide wavelength range in an optical monitor device for a plurality of optical fibers.

### Solution to Problem

To achieve the above object, an optical monitor device of the present disclosure is
an optical monitor device that detects an intensity of light propagating through a plurality of optical fibers, the optical monitor device including:
an optical splitting unit that splits a part of incident light into a first direction and a rest into a second direction at a specific splitting ratio, and emits light; and
a light receiving portion that receives emitted light in the second direction from the optical splitting unit,
in which the light receiving portion
includes light receiving elements larger in number than the optical fibers are two-dimensionally arranged, and
a wavelength dependent portion that causes the light receiving portion to receive light at a position on a light receiving surface that varies depending on a wavelength of the emitted light, and
obtains a wavelength of the emitted light on a basis of a position of the emitted light on the light receiving surface.

A method of the present disclosure is a method for detecting an intensity of light propagating through a plurality of optical fibers using an optical monitor device, the method including:
a splitting procedure in which an optical splitting unit splits a part of incident light from the plurality of optical fibers into a first direction and a rest into a second direction at a constant splitting ratio; and
a light receiving procedure in which a light receiving portion receives emitted light in a second direction from the optical splitting unit,
in which in the light receiving procedure,
a wavelength dependent portion causes the light receiving portion to receive light at a position on a light receiving surface that varies depending on a wavelength of the emitted light, and
a wavelength of the emitted light is obtained on a basis of a position of the emitted light on the light receiving surface.

An optical monitor device of the present disclosure is an optical monitor device that detects an intensity of light propagating through a plurality of optical fibers, in which emitted light in the second direction is transmitted through the wavelength dependent portion and reaches the light receiving portion at an emission angle that varies depending on a wavelength. Therefore, in the present disclosure, since a light intensity detected by each light receiving element of the light receiving portion is changed depending on the wavelength, a wavelength that has reached can be known from this change. As a result, the optical monitor device of the present disclosure can measure wavelengths and light intensities of a plurality of optical fibers.

The optical splitting unit may include: a single-layer film having a uniform thickness; an incident-side member included on an incident side of the single-layer film and having a refractive index different from a refractive index of the single-layer film; and an emission-side member included on an emission side of the single-layer film and having a same refractive index as a refractive index of the incident-side member. In this case, each of a first refractive index interface between the single-layer film and the incident-side member and a second refractive index interface between the single-layer film and the emission-side member may be included at a specific angle with respect to an optical axis of incident light, the first direction may be a direction in which transmission occurs through the first refractive index interface and the second refractive index interface, and the second direction may be a direction in which reflection occurs on the first refractive index interface and the second refractive index interface.

The wavelength dependent portion may be an optical prism on which emitted light in the second direction is made incident and that emits light in a direction depending on a wavelength of corresponding emitted light. In this case, a light receiving surface of the light receiving portion may be substantially perpendicular to transmitted light of the optical prism. A distance between the optical prism and the array-type light receiving element may be sufficiently larger than a thickness of the single-layer film.

An optical monitor device of the present disclosure may include:
a plurality of incident-side optical fibers that is two-dimensionally arranged so as to make light incident on the optical splitting unit;
a plurality of emission-side optical fibers that is two-dimensionally arranged to receive each piece of emitted light from the optical splitting unit in the first direction;
an incident-side optical lens that is arranged between the optical splitting unit and the incident-side optical fibers and collimates each piece of incident light to the optical splitting unit; and
an emission-side optical lens that is arranged between the optical splitting unit and the emission-side optical fibers and couples each piece of emitted light from the optical splitting unit to the emission-side optical fibers.

Note that the disclosures described above can be combined in any possible manner.

### Advantageous Effects of Invention

The present disclosure can make it possible to monitor wavelengths of optical signals in a wide wavelength range in an optical monitor device for a plurality of optical fibers.

### BRIEF DESCRIPTION OF DRAWINGS

FIG. 1 illustrates an exemplary embodiment of an optical monitor device of the present disclosure.

FIG. 2 illustrates an example of light propagating through a spatial optical system.

FIG. 3A illustrates an example of images of emitted light that has reached light receiving elements.

FIG. 3B illustrates an example of images of emitted light that has reached the light receiving elements.

FIG. 4 illustrates an arrangement example of incident-side optical fibers.

FIG. 5A illustrates an example of images of emitted light that has reached the light receiving elements.

FIG. 5B illustrates an example of images of emitted light that has reached the light receiving elements.

FIG. 6 illustrates an example of a light intensity and wavelength measurement method of the present disclosure.

### DESCRIPTION OF EMBODIMENTS

Hereinafter, embodiments of the present disclosure will be described in detail with reference to the drawings. Note that the present disclosure is not limited to the embodiments described below. These embodiments are merely examples, and the present disclosure can be implemented in a form with various modifications and improvements on the basis of the knowledge of those skilled in the art. Note that components having the same reference signs in the present specification and the drawings indicate the same components.

### First Embodiment

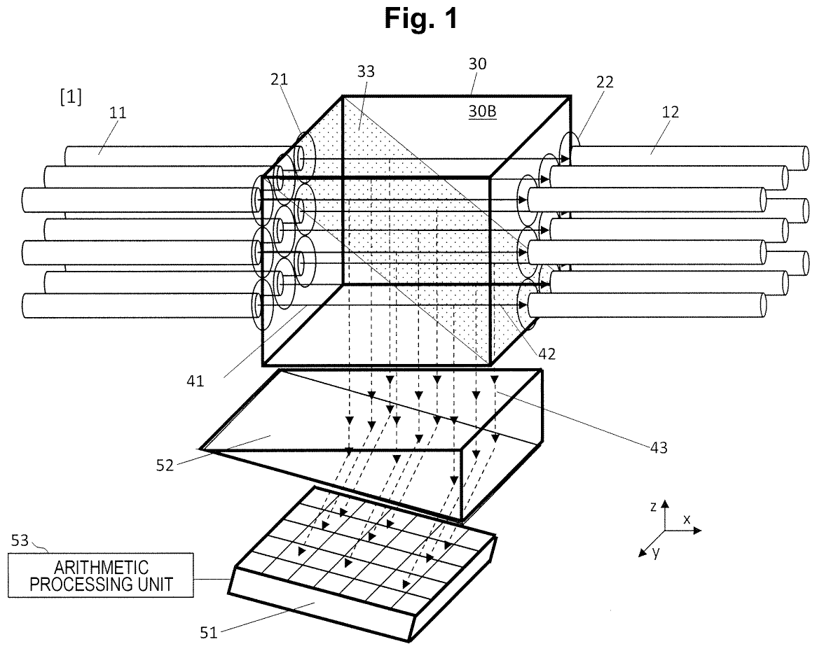

An optical monitor device of the present embodiment has a configuration illustrated in FIG. 1.

The optical monitor device of the present embodiment is an optical monitor device that detects an intensity of light propagating through a plurality of incident-side optical fibers 11, the optical monitor device including:
a spatial optical system 30 that splits most incident light 41 into a specific first direction and the rest into a different specific second direction at a constant splitting ratio for each piece of the incident light 41 from the incident-side optical fibers 11, and emits each piece of split light;
the incident-side optical fibers 11 that are two-dimensionally arranged so as to make light incident on the spatial optical system 30, and propagate a plurality of pieces of light;
emission-side optical fibers 12 that are arranged to receive most emitted light 42 emitted from the spatial optical system 30 in the first direction, and propagate a plurality of pieces of light;
an array-type light receiving element 51 that is arranged to receive a part of the emitted light 43 emitted from the spatial optical system 30 in the second direction;
an incident-side optical lens 21 that is arranged between the spatial optical system 30 and the incident-side optical fibers 11 and collimates each piece of incident light from the incident-side optical fibers 11 to the spatial optical system 30; and
an emission-side optical lens 22 that is arranged between the spatial optical system 30 and the emission-side optical fibers 12 and efficiently couples each piece of emitted light from the spatial optical system 30 to the emission-side optical fibers 12 corresponding to the incident side optical fibers 11.

According to the present disclosure, when the array-type light receiving element 51 receives emitted light in the second direction, at least one of
(i) a light intensity received by the array-type light receiving element 51,
(ii) a light intensity of incident light that is made incident from the plurality of incident-side optical fibers 11, or
(iii) a light intensity of emitted light emitted to the plurality of emission-side optical fibers 12 can be measured.

FIG. 1 illustrates an example in which the first direction is the x-axis direction and the second direction is the z-axis direction. Furthermore, in the present disclosure, the spatial optical system 30 functions as an “optical splitting unit” of the present disclosure, and the array-type light receiving element 51 functions as a “light receiving portion” of the present disclosure.

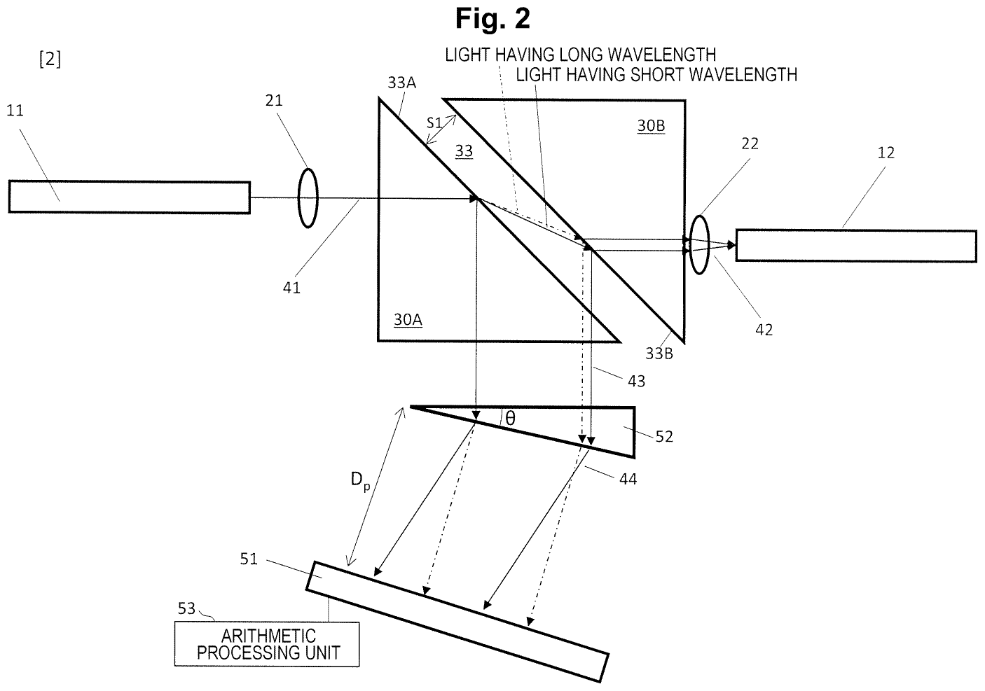

Furthermore, in the optical monitor device of the present embodiment, as illustrated in FIG. 2, the spatial optical system 30 includes a single-layer film 33 having a uniform refractive index included between an incident-side member 30A and an emission-side member 30B each including a material having a different uniform refractive index, and the single-layer film 33 is included at a specific angle (45 degrees in the drawing) with the optical axis of the incident light 41. As a result, each of a first refractive index interface 33A between the single-layer film 33 and the incident-side member 30A and a second refractive index interface 33B between the single-layer film 33 and the emission-side member 30B is included at a specific angle with the optical axis of the incident light 41.

FIGS. 1 and 2 illustrate an example in which the specific angle is 45 degrees and the direction of the emitted light 43 is 90 degrees, but the direction of the emitted light 43 is not fixed to 90 degrees and can be changed as necessary. Furthermore, the spatial optical system 30 is not limited to a spatial system, and any optical component including a splitting surface capable of splitting light into two pieces of light having different directions can be used.

According to the optical monitor device illustrated in FIGS. 1 and 2, incident light from the incident-side optical fibers 11 becomes parallel light in the incident-side optical lens 21, and thus a loss due to diffusion can be prevented. Further, most emitted light 42 is guided to the emission-side optical lens 22 by the spatial optical system 30. The emission-side optical lens 22 collects light passing through the spatial optical system 30 and is coupled to the emission-side optical fibers 12. In this manner, most emitted light emitted from the incident-side optical fibers 11 can be guided to the emission-side optical fibers 12 with a small loss.

On the other hand, a part of the emitted light 43 split by the spatial optical system 30 is refracted by an optical prism 52 arranged in a direction different from the most emitted light 42, and transmitted light 44 from the optical prism 52 is guided to the array-type light receiving element 51. The optical prism 52 functions as a “wavelength dependent portion” of the present disclosure, and the refraction angle in the optical prism 52 changes depending on the wavelength. As a result, since an arithmetic processing unit 53 changes the amounts of light incident on respective elements of the array-type light receiving element 51 depending on two factors of the light intensities and the wavelengths of the incident-side optical fibers 11, the optical monitor device of the present embodiment can measure the intensities and the wavelengths of light propagated from the incident-side optical fibers 11 to the emission-side optical fibers 12 from this change.

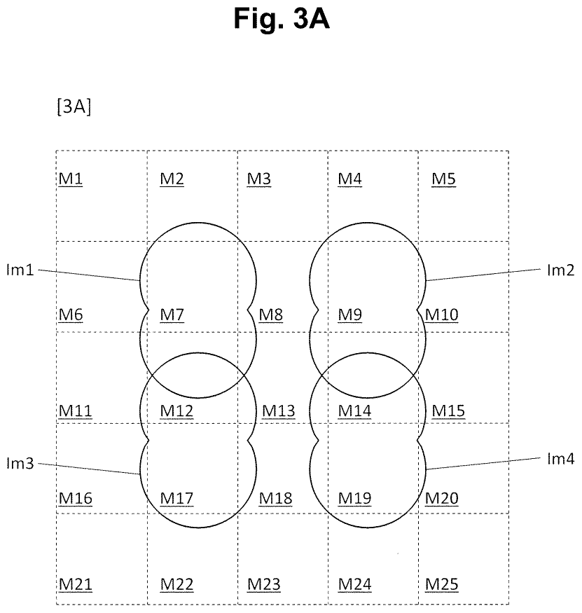

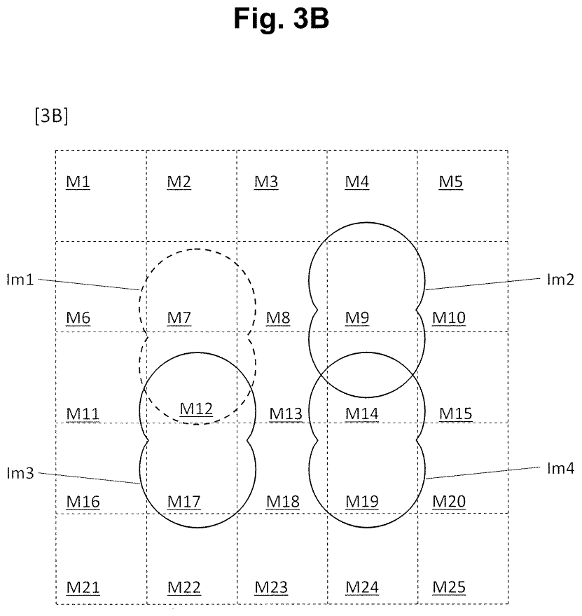

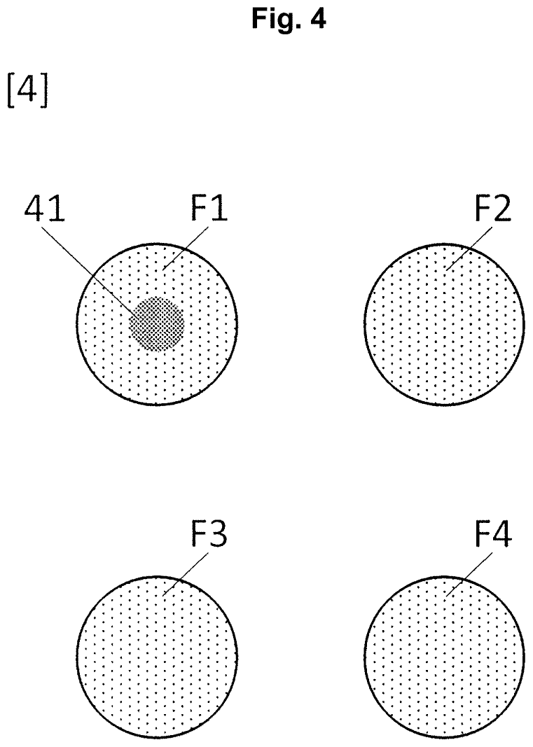

FIGS. 3A and 3B illustrate arrangement of the light receiving elements on the light receiving surface of the array-type light receiving element 51 and images of the emitted light 43 that has arrived from the incident-side optical fibers 11. As an example, assume that four incident-side optical fibers F1 to F4 are two-dimensionally arranged at a constant pitch by two and emit light having the same wavelength λ0 as illustrated in FIG. 4. Assume also that 25 light receiving elements M1 to M25 are two-dimensionally arranged at a constant pitch. In the present disclosure, the pitch of the incident-side optical fibers F1 to F4 do not match the pitch of the light receiving elements M1 to M25, and no special alignment is performed. At this time, on the light receiving surface of the array-type light receiving element 51, four images Im1 to Im4 of the emitted light 43 are formed at positions corresponding to the arrangement of the incident-side optical fibers F1 to F4 as illustrated in FIG. 3A.

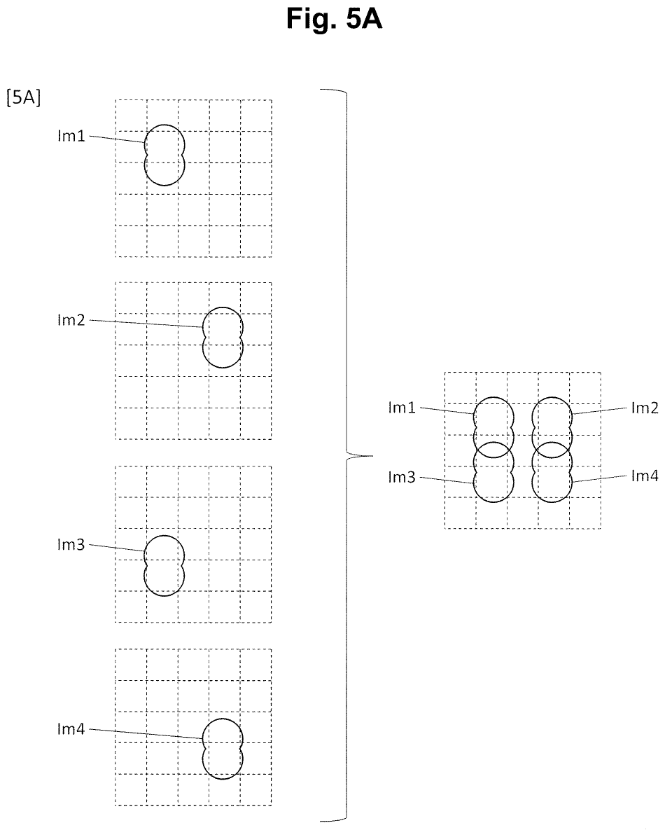

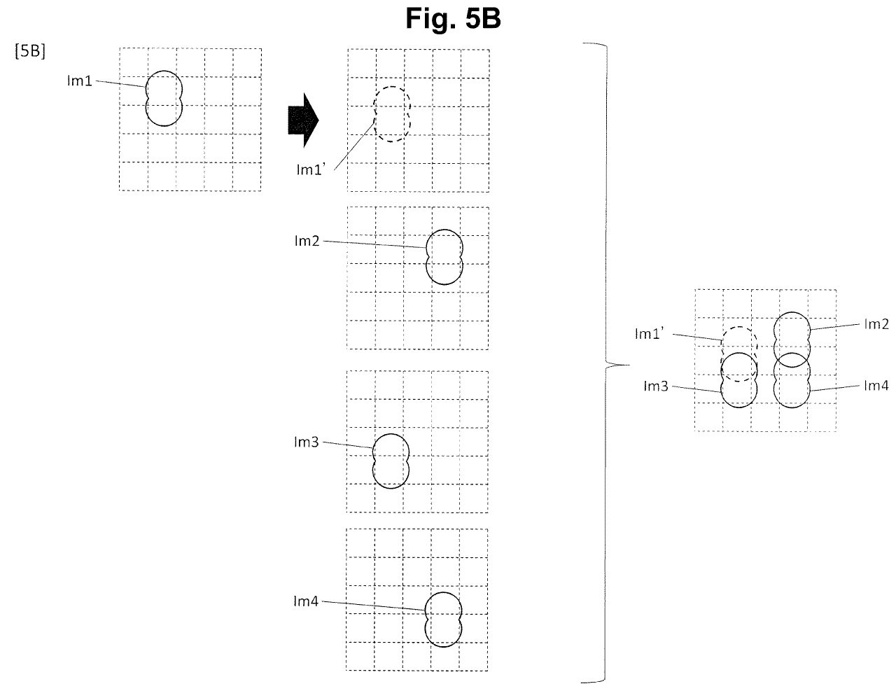

Here, if the light receiving surface of the array-type light receiving element 51 is arranged so as to be substantially perpendicular to the transmitted light 44 emitted from the optical prism 52, in a case where a wavelength λ1 of the incident light 41 from the incident-side optical fiber F1 changes, the refraction angle in the optical prism 52 changes, and thus the positions of the images Im1 to Im4 on the light receiving surface change. For example, assume that the position of an image Im1 of the incident-side optical fiber F1 has changed as Im1′ indicated by a dotted line in FIG. 5B.

At this time, as illustrated in FIG. 5A, the images of FIG. 3A are equal to the sum of images (reference images) from the respective incident-side optical fibers F1 to F4. Therefore, as illustrated in FIG. 5B, the images of FIG. 3B are equal to a result obtained by moving a reference image of the incident-side optical fiber F1 by the movement amount of the position of the image based on the difference in wavelength and then adding images of the other incident-side optical fibers F2 to F4.

Output matrices (reference matrices) of the array-type light receiving element 51 when light having the unit light intensity of a wavelength λ0 is individually emitted from the incident-side optical fibers F1 to F4 are represented by SF1 to SF4, and an output matrix X0 of the array-type light receiving element 51 when each of the incident-side optical fibers F1 to F4 emits light with a light intensity PF1 to PF4 is represented by the following Formula 1.

$$[ Math . 1 ]$$

$$XO + \{ \begin{matrix}SF 1 & SF 2 & SF 3 & SF 4\end{matrix} \} ( \begin{matrix}PF 1 \\ PF 2 \\ PF 3 \\ PF 4\end{matrix} ) \qquad ( Formula 1 )$$

At this time, the light intensities PF1 to PF4 of the respective optical fibers can be obtained by the following Formula 2 using a generalized inverse matrix {SF1 SF2 SF3 SF4}⁺ of {SF1 SF2 SF3 SF4}.

$$[ Math . 2 ]$$

$$\begin{matrix}( \begin{matrix}PF 1 \\ PF 2 \\ PF 3 \\ PF 4\end{matrix} ) = {\{ \begin{matrix}SF 1 & SF 2 & SF 3 & SF 4\end{matrix} \}}^{+} XO & ( Formula 2 )\end{matrix}$$

By the reference matrices being measured in advance, the light intensities of the respective incident-side optical fibers F1 to F4 when the wavelengths of all the incident-side optical fibers F1 to F4 are λ0 can be calculated from the output matrix X0 of the array-type light receiving element 51.

Here, for example, when the wavelength of the incident-side optical fiber F1 is changed to λ1, the light intensity of the image Im1′ at the wavelength λ1 can be obtained similarly to the case of λ0 by using a reference matrix SF1′ obtained by moving a matrix SF1 by the movement amount of the image Im1 corresponding to λ1. In a case where a distance Dp between the optical prism 52 and the array-type light receiving element 51 is sufficiently larger than the thickness of the single-layer film 33, the movement amount of the image Im1 is determined by a change in the refraction angle due to a change in the wavelength and the distance Dp. Since the change in the refraction angle is determined by a vertex angle θ and a refractive index np of the prism, the movement amount of the image according to the change in the wavelength can be calculated by the refractive index np of the prism, the vertex angle θ, and the distance Dp between the optical prism 52 and the array-type light receiving element 51 being known in advance.

Therefore, a light intensity wavelength measurement method of the present embodiment is
a method for detecting an intensity of light propagating through a plurality of optical fibers using an optical monitor device, the method including:
a splitting procedure in which the spatial optical system 30 splits a part of incident light from the plurality of optical fibers 11 into a first direction and a rest into a second direction at a constant splitting ratio; and
a light receiving procedure in which the array-type light receiving element 51 receives emitted light 43 in a second direction from the spatial optical system 30,
in which in the light receiving procedure,
the optical prism 52 causes the array-type light receiving element 51 to receive light at a position on a light receiving surface that varies depending on a wavelength of the emitted light 43, and
a wavelength of the emitted light 43 is obtained on the basis of a position of the emitted light 43 on the light receiving surface.

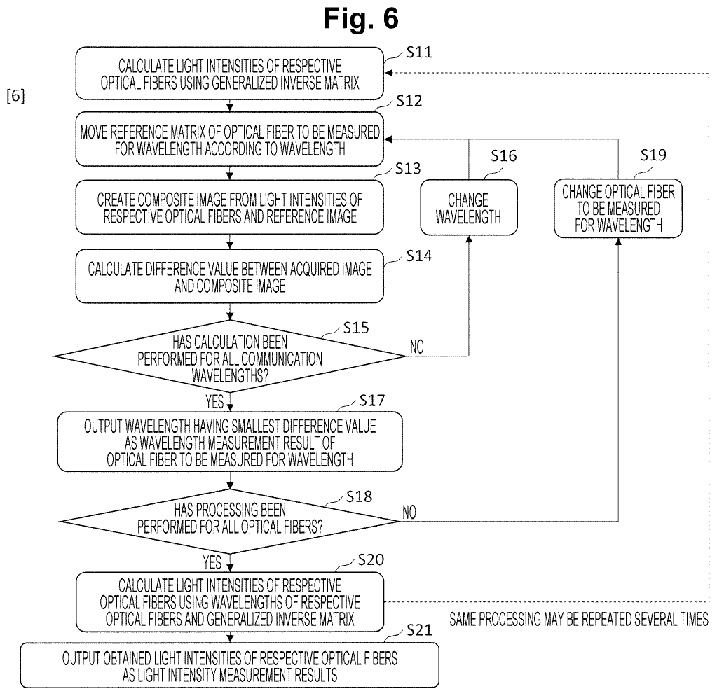

Specifically, in the light receiving procedure, as illustrated in FIG. 6, the arithmetic processing unit 53 calculates the light intensities of the respective incident-side optical fibers F1 to F4 using Formula 2 (S11), calculates an output matrix using Formula 1 while changing the wavelength of the reference matrix for each of the incident-side optical fibers F1 to F4 using the calculated light intensity (S12 to S15), and obtains the wavelength closest to the actual output matrix (S17), thereby obtaining the wavelengths of the respective incident-side optical fibers F1 to F4 (S18 to S21).

Specifically, in calculation of an output matrix,
the reference matrix SF1′ of an optical fiber to be measured for the wavelength is moved according to the wavelength (S12),
a composite image is created using a reference image obtained by the reference matrix SF1′ (S13),
a difference value between an image received by the array-type light receiving element 51 and the created composite image is calculated (S14), and
the calculation of this difference value is performed for all communication wavelengths (S15).

In step S17, a wavelength having the smallest difference value among difference values calculated in step S14 is output as the wavelength measurement result of the optical fiber to be measured for the wavelength.

The arithmetic processing unit 53 can obtain the wavelengths of the respective incident-side optical fibers F1 to F4 by performing steps S12 to S17 on each of the incident-side optical fibers F1 to F4 (S18). The arithmetic processing unit 53 calculates the light intensities of the respective incident-side optical fibers F1 to F4 using the obtained wavelengths of the respective incident-side optical fibers F1 to F4 and the generalized inverse matrix {SF1 SF2 SF3 SF4}⁺ (S20). As a result, the arithmetic processing unit 53 outputs the wavelengths and the light intensities of the respective optical fibers F1 to F4 as light intensity measurement results.

As indicated by a broken line arrow in FIG. 6, the arithmetic processing unit 53 once again calculates the light intensities by Formula 2 after obtaining the wavelengths of the respective incident-side optical fibers F1 to F4, thereby calculating more accurate light intensities. In this case, the second step is required to be “set a reference matrix of each of the incident-side optical fibers F1 to F4 to a position according to the previous wavelength measurement result, and then move the reference matrix of an incident-side optical fiber F1 to F4 to be measured for the wavelength according to the wavelength”. Furthermore, by this processing being repeated several times, more accurate calculation of the wavelengths and the light intensities can be expected.

### Effects of Present Disclosure

As described above, in the optical monitor device of the present disclosure that detects an intensity of light propagating through the plurality of optical fibers, incident light is split using the single-layer film 33 having a uniform thickness. The emitted light 34 in the second direction of the split incident light is transmitted through the optical prism 52 and reaches the array-type light receiving element 51 at an emission angle that varies depending on the wavelength. Therefore, since the light intensities detected by the respective light receiving elements are changed depending on the wavelength, a wavelength that has reached can be known from this change. Therefore, the present disclosure can collectively measure the light intensities and the wavelengths of optical signals passing through the plurality of optical fibers.

Although the above is the exemplary embodiments, the present invention is not limited thereto. For example, although the example has been described in which the wavelength dependent portion is the optical prism 52, the wavelength dependent portion is not limited to the form using wavelength dependency of a refraction angle, and any form can be adopted, such as a form using the wavelength dependency of a reflection angle, in which emitted light in the second direction can be made incident on a position on the light receiving surface of the array-type light receiving element 51 that varies depending on the wavelength.

Furthermore, in the present disclosure, the example has been described in which the single-layer film 33 is an air layer, but the single-layer film may be glass or resin. Furthermore, the spatial optical system 30 is not limited to a cubic shape, and may have any shape such as a rectangular parallelepiped. Furthermore, the array-type light receiving element 51 can be arranged at any position where light split by the spatial optical system 30 can be received.

Furthermore, the optical monitor device of the present disclosure can be used for monitoring any light transmitted in an optical transmission system. For example, the optical monitor device of the present disclosure can be incorporated in any device used in an optical transmission system such as a transmission device, a reception device, or a relay device, and a measurement result in the array-type light receiving element 51 can be used for feedback or feedforward to any component inside or outside the device. Furthermore, the optical monitor device of the present disclosure can be inserted in the middle of a transmission line in an optical transmission system so as to measure the intensity and a propagation loss of an optical signal in the transmission line.

The arithmetic processing unit 53 included in the optical monitor device of the present disclosure can also be implemented by a computer and a program, and the program can be recorded in a recording medium or provided through a network. A program of the present disclosure is a program for causing a computer to implement the arithmetic processing unit 53 included in the optical monitor device of the present disclosure, and is a program for causing a computer to execute each step included in the method executed by the optical monitor device according to the present disclosure.

### INDUSTRIAL APPLICABILITY

The present disclosure can be applied to information and communication industries.

### REFERENCE SIGNS LIST

11 Incident-side optical fiber
12 Emission-side optical fiber
21 Incident-side optical lens
22 Emission-side optical lens
30 Spatial optical system
30A Incident-side member
30B Emission-side member
33 Single-layer film
51 Array-type light receiving element
52 Optical prism
53 Arithmetic processing unit

1. An optical monitor device that detects an intensity of light propagating through a plurality of optical fibers, the optical monitor device comprising:
an optical splitting unit that splits a part of incident light from the plurality of optical fibers into a first direction and a rest into a second direction at a constant splitting ratio, and emits light; and
a light receiving portion that receives emitted light in the second direction from the optical splitting unit,
wherein the light receiving portion
includes light receiving elements larger in number than the optical fibers are two-dimensionally arranged, and
a wavelength dependent portion that causes the light receiving portion to receive light at a position on a light receiving surface that varies depending on a wavelength of the emitted light, and
obtains a wavelength of the emitted light on a basis of a position of the emitted light on the light receiving surface.

2. The optical monitor device according to claim 1,
wherein the wavelength dependent portion is an optical prism on which emitted light in the second direction is made incident and that emits light in a direction different depending on a wavelength of corresponding emitted light, and
a light receiving surface of the light receiving portion is substantially perpendicular to transmitted light of the optical prism.

3. The optical monitor device according to claim 1,
wherein the optical splitting unit includes:
a single-layer film having a uniform thickness;
an incident-side member included on an incident side of the single-layer film and having a refractive index different from a refractive index of the single-layer film; and
an emission-side member included on an emission side of the single-layer film and having a same refractive index as a refractive index of the incident-side member,
each of a first refractive index interface between the single-layer film and the incident-side member and a second refractive index interface between the single-layer film and the emission-side member is included at a specific angle with respect to an optical axis of incident light,
the first direction is a direction in which transmission occurs through the first refractive index interface and the second refractive index interface, and
the second direction is a direction in which reflection occurs on the first refractive index interface and the second refractive index interface.

4. The optical monitor device according to claim 3, wherein a distance between the wavelength dependent portion and the light receiving portion is larger than a thickness of the single-layer film.

5. A method for detecting an intensity of light propagating through a plurality of optical fibers using an optical monitor device, the method comprising:
a splitting procedure in which an optical splitting unit splits a part of incident light from the plurality of optical fibers into a first direction and a rest into a second direction at a constant splitting ratio; and
a light receiving procedure in which a light receiving portion receives emitted light in the second direction from the optical splitting unit,
wherein in the light receiving procedure,
a wavelength dependent portion causes the light receiving portion to receive light at a position on a light receiving surface that varies depending on a wavelength of the emitted light, and
a wavelength of the emitted light is obtained on a basis of a position of the emitted light on the light receiving surface.
